(19) United States
(12) Patent Application Publication
(10) Pub. No.: US 2020/0118354 A1
(43) Pub. Date: Apr. 16, 2020

(54) VEHICLE DIAGNOSTIC DEVICE WITH A VIRTUAL VEHICLE DIAGNOSTIC MODE AND METHOD OF OPERATING THE SAME

(71) Applicant: Bendix Commercial Vehicle Systems LLC, Elyria, OH (US)

(72) Inventors: Timothy J. Frashure, Columbia Station, OH (US); Mathew Fry, North Somerset (DE)

(21) Appl. No.: 16/160,293

(22) Filed: Oct. 15, 2018

(51) Int. Cl. G07C 5/00; G06F 8/65

(52) U.S. Cl. CPC G07C 5/008; G06F 3/0482; G06F 8/65

(57) ABSTRACT

A vehicle diagnostic device comprises a first mode of operation in which a user can perform vehicle diagnostics on an actual vehicle that is physically connected to the vehicle diagnostic device. The vehicle diagnostic device also comprises a second mode of operation in which a user can demonstrate vehicle diagnostics on a virtual vehicle without an actual vehicle having to be physically connected to the vehicle diagnostic device.

### BACKGROUND

The present application relates to vehicle diagnostic devices, and is particularly directed to a vehicle diagnostic device with a virtual vehicle diagnostic mode and method of operating the same.

Some vehicle diagnostic devices have a diagnostic mode and a demo mode. In the diagnostic mode, a user can perform diagnostic functions on an actual vehicle that is connected through a hardware adapter to the vehicle diagnostic device. In the demo mode, the user can demo (i.e., demonstrate) certain features of the vehicle diagnostic device. Known vehicle diagnostic devices that have a demo mode have a number of drawbacks. One drawback is that application software for the demo mode is hard-coded into the vehicle diagnostic device. The hard-coded application software for the demo mode limits the functionality of the demo mode. The hard-coded application software is also difficult to update. Those skilled in the art continue with research and development efforts in the field of vehicle diagnostic devices.

### SUMMARY

In accordance with one embodiment, a vehicle diagnostic device comprises a first mode of operation in which a user can perform vehicle diagnostics on an actual vehicle that is physically connected to the vehicle diagnostic device. The vehicle diagnostic device also comprises a second mode of operation in which a user can demonstrate vehicle diagnostics on a virtual vehicle without an actual vehicle having to be physically connected to the vehicle diagnostic device.

In accordance with another embodiment, a vehicle diagnostic device comprises a memory unit configured to store (i) a selection program, and (ii) one or more virtual vehicle diagnostic applications. The vehicle diagnostic device also comprises a processor unit configured to (i) execute instructions contained in the selection program to prompt the user to select one of the one or more virtual vehicle diagnostic applications, and (ii) execute instructions contained in the selected one of the one or more virtual vehicle diagnostic applications to prompt the user to perform vehicle diagnostics on a virtual vehicle.

In accordance with yet another embodiment, a method is provided of operating a vehicle diagnostic device. The method comprises retrieving a virtual vehicle diagnostic application when a user selects a virtual vehicle diagnostic mode of the vehicle diagnostic device. The method also comprises displaying screens to prompt the user to perform vehicle diagnostics on a virtual vehicle using the retrieved virtual vehicle diagnostic application.

### BRIEF DESCRIPTION OF THE DRAWINGS

FIG. 1 is a block diagram of an example vehicle diagnostic device constructed in accordance with an embodiment.

FIG. 2 is a flow diagram depicting an example method of operating a vehicle diagnostic device in accordance with an embodiment.

### DETAILED DESCRIPTION

The present application is directed to a vehicle diagnostic device with a virtual vehicle diagnostic mode and method of operating the same. The specific construction of the vehicle diagnostic device and the industry in which the device is implemented may vary. It is to be understood that the disclosure below provides a number of embodiments or examples for implementing different features of various embodiments. Specific examples of components and arrangements are described to simplify the present disclosure. These are merely examples and are not intended to be limiting.

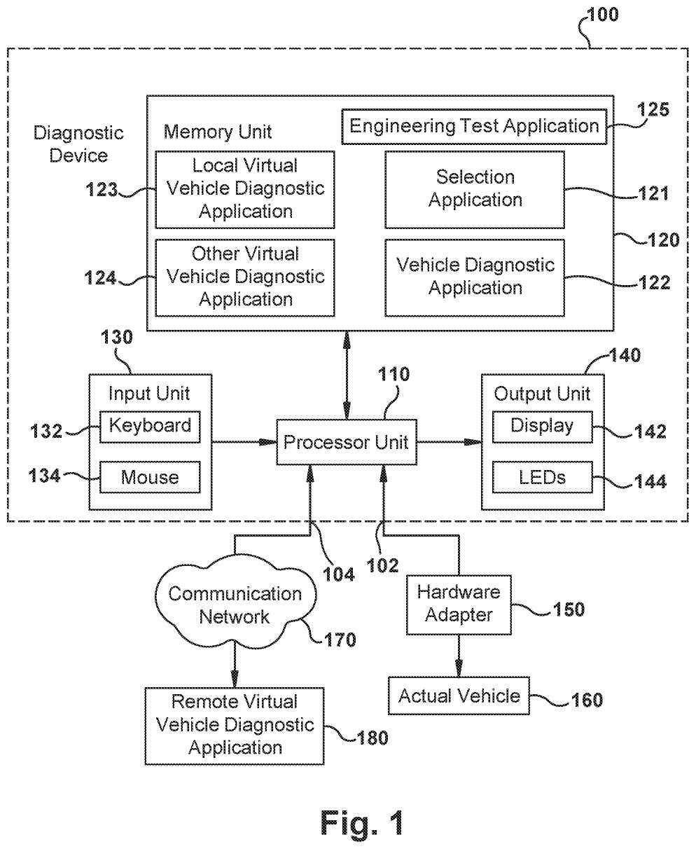

Referring to FIG. 1, a block diagram of an example vehicle diagnostic device 100 constructed in accordance with an embodiment is illustrated. An existing model of a vehicle diagnostic device can be modified to provide vehicle diagnostic device 100 shown in FIG. 1. For example, model ACom® manufactured by Bendix Commercial Vehicle Systems LLC located in Elyria, Ohio can be modified to provide vehicle diagnostic device 100. Modifications of other models of vehicle diagnostic device are possible.

Vehicle diagnostic device 100 includes processor unit 110 that executes instructions stored in internal memory unit 120, external memory unit (not shown), or a combination thereof. Processor unit 110 may comprise any type of technology. For example, processor unit 110 may comprise a dedicated-purpose electronic processor. Other types of processors and processor unit technologies are possible.

Memory unit 120 may comprise any type of data storage technology. For examples, memory unit 120 may comprise random access memory (RAM), read only memory (ROM), solid state memory, or any combination thereof. Other types of memories and data storage technologies are possible. As shown in FIG. 1, a selection application 121, a non-virtual vehicle application 122, a local virtual vehicle diagnostic application 123, another virtual vehicle diagnostic application 124, and an engineering test application 125 are stored in the memory unit 120.

Vehicle diagnostic device 100 further includes an input unit 130 that has a number of input devices such as a keyboard 132 and a mouse 134. Other types of input devices and technologies are possible. Vehicle diagnostic device 100 further includes an output unit 140 that has a number of output devices such as a display 142 and an array of light emitting diodes (LEDs) 144. Other types of output devices and technologies are possible.

Processor unit 110 is configured to execute instructions contained in the selection program 121 to prompt the user to select one of the non-virtual vehicle diagnostic application 122, the local virtual vehicle diagnostic application 123, the other virtual vehicle diagnostic application 124, and the engineering test application 125.

Vehicle diagnostic device 100 is connectable via a first port 102 through a hardware adapter 150 to an actual vehicle 160. Hardware adapter 150 depends upon the particular make of the actual vehicle 160. Vehicle diagnostics are performed on the actual vehicle 160 in response to signals from the processor unit 110. More specifically, processor unit 110 is configured to execute instructions contained in the non-virtual vehicle diagnostic application 122 stored in memory unit 120 to prompt a user to perform vehicle diagnostics on the actual vehicle 160. Structure and operation of vehicle diagnostic devices through suitable hardware adapters to perform vehicle diagnostics on actual vehicles based on non-virtual vehicle diagnostic applications are conventional and, therefore, will not be further described.

Vehicle diagnostic device 100 is connectable via a second port 104 through a communication network 170 to a virtual vehicle diagnostic application 180 that is stored at a remote location. Communication network 170 may comprise the Internet, for example. Vehicle diagnostics are performed on a virtual vehicle (not shown as it does not physically exist) in response to signals from the processor unit 110. More specifically, processor unit 110 is configured to execute instructions contained in either the local virtual vehicle diagnostic application 123 or the other virtual vehicle diagnostic application 124 to prompt a user to perform vehicle diagnostics on the virtual vehicle.

The processor unit 110 is also configured to execute instructions contained in the engineering test application 125 to prompt a user to perform engineering tests on the non-virtual vehicle diagnostic application 122. Tests that can be performed on the non-virtual vehicle diagnostic application 122 include component tests, parameter changes (e.g., parameterization), and sensor responses. These are only example tests that can be performed. Other types of tests are possible.

The above-described vehicle diagnostic device 100 has various modes of operation. A first mode of operation is user-selectable in which a user can perform vehicle diagnostics on the actual vehicle 160 that is physically connected (e.g., through the hardware adapter 150) to the vehicle diagnostic device 100. A second mode of operation is user-selectable in which a user can demonstrate vehicle diagnostics on a virtual vehicle without an actual vehicle having to be physically connected to the vehicle diagnostic device 100. A third mode of operation is user-selectable in which a user can perform engineering tests on a vehicle diagnostic application (e.g., the non-virtual vehicle diagnostic application 122) that is stored on the vehicle diagnostic device 100.

The vehicle diagnostic device 100 provides a selection mode in which a user can select one of the first, second, and third modes of operation. The vehicle diagnostic device 100 also provides an update mode in which a user can update a virtual vehicle diagnostic application (e.g., the local virtual vehicle diagnostic application 123 or the other virtual vehicle diagnostic application 124) associated with the second mode of operation described hereinabove. The local virtual vehicle diagnostic application 123 is stored at a local location relative to the user, and may have been initially installed and stored in the memory unit 120. The other virtual vehicle diagnostic application 124 is also stored at a local location relative to the user, but may have been subsequently downloaded from a remote location (e.g., the remote virtual vehicle diagnostic application 180).

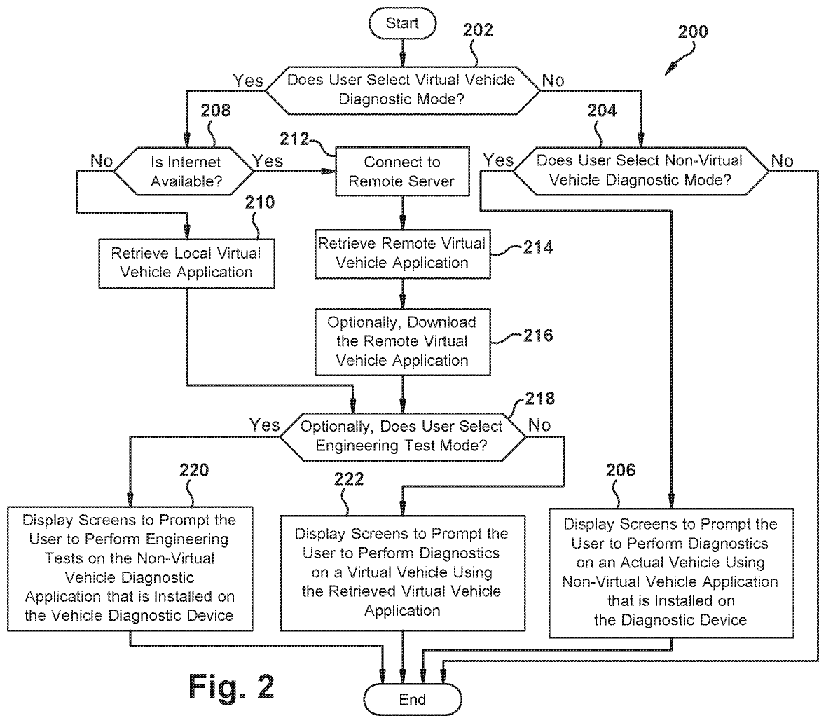

Referring to FIG. 2, a flow diagram 200 depicting an example method of operating a vehicle diagnostic device in accordance with an embodiment is illustrated. In block 202, a determination is made as to whether a user selects a virtual vehicle diagnostic mode. If the determination in block 202 is negative (i.e., the user does not select a virtual vehicle diagnostic mode), the process proceeds to block 204. In block 204, a determination is made as to whether the user selects a non-virtual vehicle diagnostic mode. If the determination in block 204 is negative (i.e., the user does not select a non-virtual vehicle diagnostic mode), the process ends.

However, if the determination in block 204 is affirmative (i.e., the user does select a non-virtual vehicle diagnostic mode), the process proceeds to block 206. In block 206, screens are displayed to prompt a user to perform vehicle diagnostics on an actual vehicle using a non-virtual vehicle diagnostic application that is installed on the vehicle diagnostic device. The process then ends.

If the determination back in block 202 is affirmative (i.e., the user selects a virtual vehicle diagnostic mode), the process proceeds to block 208 in which a determination is made as to whether an Internet connection is available. If the determination in block 208 is negative (i.e., no Internet connection is available), the process proceeds to block 210. In block 210, a local virtual vehicle application is retrieved. The process then proceeds to block 218. However, if the determination in block 208 is affirmative (i.e., an Internet connection is available), the process proceeds to block 212.

In block 212, the vehicle diagnostic device is connected over the Internet to a remote server. A remote virtual vehicle application is retrieved from the remote server, as shown in block 214. Then, optionally as shown in block 216, the retrieved remote virtual vehicle application is downloaded from the remote server to the vehicle diagnostic device. The process then proceeds to block 218.

In block 218, which is optional, a determination is made as to whether the user selects engineering test mode. If the determination in block 218 is affirmative (i.e., the user selects engineering test mode), the process proceeds to block 220. In block 220, screens are displayed to prompt the user to perform engineering tests on the non-virtual vehicle diagnostic application that is installed on the vehicle diagnostic device. The process then ends.

However, if the determination in block 218 is negative (i.e., the user does not select engineering test mode), the process proceeds to block 222. In block 222, screens are displayed to prompt the user to perform vehicle diagnostics on a virtual vehicle using the retrieved virtual vehicle application (i.e., either the local virtual vehicle diagnostic application retrieved in block 210 or the remote virtual vehicle diagnostic application retrieved in block 214). The process then ends.

It should be apparent that the above-described vehicle diagnostic device 100 allows a user to select one of one or more virtual vehicle diagnostic applications to prompt the user to perform vehicle diagnostics (i.e., perform a diagnostic session) on a virtual vehicle without having to be physically connected to an actual vehicle. The virtual vehicle emulates diagnostic functions using the same interface messages as that of an actual vehicle. This is accomplished by using a web interface to run either a local application (e.g., the local virtual vehicle diagnostic application 123) or a remote application (e.g., the remote virtual vehicle diagnostic application 180) that is in the cloud.

It should also be apparent that the above-described vehicle diagnostic device 100 is separate from the remote virtual vehicle diagnostic application 180, and is therefore not hard-coded. This allows the software of the remote virtual vehicle diagnostic application 180 to be easily updated or customized on its own schedule without impacting the functionality or release timing of the vehicle diagnostic device 100. Moreover, the same connections and virtual vehicle model can be used for different kinds and versions of vehicle diagnostic devices.

It should further be apparent that it is easy for a user to see that the vehicle diagnostic device 100 is running in demo mode using a virtual vehicle since the vehicle diagnostic device 100 is not connected to an actual vehicle. Moreover, the demo mode using a virtual vehicle instead of an actual vehicle also acts as a quick validation test for a user to see since the same interface messages as an actual vehicle are used.

Although the above description describes two virtual vehicle diagnostic applications (i.e., local virtual vehicle diagnostic application 123 and other virtual vehicle diagnostic application 124) stored in memory unit 120, it is conceivable that any number of applications (including only one application) be stored in memory unit 120. Moreover, multiple versions of applications can be used depending on what features or functions need to be demonstrated for the particular vehicle diagnostic device 100.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A vehicle diagnostic device comprising:
a first mode of operation in which a user can perform vehicle diagnostics on an actual vehicle that is physically connected to the vehicle diagnostic device; and
a second mode of operation in which a user can demonstrate vehicle diagnostics on a virtual vehicle without an actual vehicle having to be physically connected to the vehicle diagnostic device.

2. A vehicle diagnostic device according to claim 1, further comprising:
a third mode of operation in which a user can perform engineering tests on a non-virtual vehicle diagnostic application that is stored on the vehicle diagnostic device.

3. A vehicle diagnostic device according to claim 2, further comprising:
a selection mode in which a user can select one of the first, second, and third modes of operation.

4. A vehicle diagnostic device according to claim 3, further comprising:
an update mode in which a user can update a virtual vehicle diagnostic application associated with the second mode of operation.

5. A vehicle diagnostic device according to claim 1, further comprising:
an update mode in which a user can update a virtual vehicle diagnostic application associated with the second mode of operation.

6. A vehicle diagnostic device according to claim 5, wherein the virtual vehicle diagnostic application associated with the second mode of operation is stored at a local location.

7. A vehicle diagnostic device comprising:
a memory unit configured to store (i) a selection program, and (ii) one or more virtual vehicle diagnostic applications; and
a processor unit configured to (i) execute instructions contained in the selection program to prompt the user to select one of the one or more virtual vehicle diagnostic applications, and (ii) execute instructions contained in the selected one of the one or more virtual vehicle diagnostic applications to prompt the user to perform vehicle diagnostics on a virtual vehicle.

8. A vehicle diagnostic device according to claim 7, wherein (i) the memory unit is further configured to store a non-virtual vehicle diagnostic application, and (ii) the processor unit is further configured to execute instructions contained in the non-virtual vehicle diagnostic application to prompt the user to perform vehicle diagnostics on an actual vehicle.

9. A vehicle diagnostic device according to claim 8, wherein (i) the memory unit is further configured to store an engineering test application, and (ii) the processor unit is further configured to execute instructions contained in the engineering test application to prompt the user to perform engineering tests on the non-virtual vehicle diagnostic application.

10. A vehicle diagnostic device according to claim 7, wherein the one or more virtual vehicle diagnostic applications includes (i) a first virtual vehicle diagnostic application that has been initially installed in the memory unit, and (ii) a second virtual vehicle diagnostic application that has been subsequently downloaded from a remote location.

11. A vehicle diagnostic device according to claim 7, wherein the processor unit is further configured to execute instructions contained in the selected one of the one or more virtual vehicle diagnostic applications to prompt the user to perform vehicle diagnostics on a virtual vehicle without having to be physically connected to an actual vehicle.

12. A method of operating a vehicle diagnostic device, the method comprising:
retrieving a virtual vehicle diagnostic application when a user selects a virtual vehicle diagnostic mode of the vehicle diagnostic device; and
displaying screens to prompt the user to perform vehicle diagnostics on a virtual vehicle using the retrieved virtual vehicle diagnostic application.

13. A method according to claim 12, wherein displaying screens to prompt the user to perform vehicle diagnostics on a virtual vehicle using the retrieved virtual vehicle diagnostic application includes:
displaying screens to prompt the user to perform vehicle diagnostics on a virtual vehicle using the retrieved virtual vehicle diagnostic application without having to be physically connected to an actual vehicle.

14. A method according to claim 12, further comprising:
displaying screens to prompt the user to perform engineering tests on a non-virtual vehicle diagnostic application when the user selects an engineering mode of the vehicle diagnostic device.

15. A method according to claim 14, further comprising:
displaying screens to prompt the user to perform vehicle diagnostics on an actual vehicle when the user selects a vehicle diagnostic mode of the vehicle diagnostic device.

16. A method according to claim 12, further comprising:
displaying screens to prompt the user to perform vehicle diagnostics on an actual vehicle when the user selects a vehicle diagnostic mode of the vehicle diagnostic device.

17. A method according to claim 12, wherein retrieving a virtual vehicle diagnostic application when a user selects a virtual vehicle diagnostic mode of the vehicle diagnostic device includes:
retrieving the virtual vehicle diagnostic application from a local location.

18. A method according to claim 12, wherein retrieving a virtual vehicle diagnostic application when a user selects a virtual vehicle diagnostic mode of the vehicle diagnostic device includes:
retrieving the virtual vehicle diagnostic application from a remote location.

19. A method according to claim 18, further comprising:
downloading the retrieved the virtual vehicle diagnostic application from the remote location, and storing the downloaded virtual vehicle diagnostic application at a local location.

20. A method according to claim 12, wherein the method is performed by a computer having a memory executing one or more programs of instructions which are tangibly embodied in a program storage medium readable by the computer.
